(19) United States
(12) Patent Application Publication
(10) Pub. No.: US 2005/0164564 A1
(43) Pub. Date: Jul. 28, 2005

(54) Terminal device of switching device

(75) Inventors: Hisao Kawata, Saitama (JP); Katsunori Kuboyama, Saitama (JP); Shinobu Takeuchi, Saitama (JP)

Correspondence Address: HAUPTMAN KANESAKA BERNER PATENT AGENTS, SUITE 300, 1700 DIAGONAL RD, ALEXANDRIA, VA, 22314-2848, US

(73) Assignee: FUJI ELECTRIC FA COMPONENTS & SYSTEMS CO., LTD., Tokyo (JP)

(21) Appl. No.: 11/009,016

(22) Filed: Dec. 13, 2004

(30) Foreign Application Priority Data
Jan. 22, 2004 (JP) 2004-014152
Aug. 23, 2004 (JP) 2004-242660

(51) Int. Cl. H01R 13/68

(52) U.S. Cl. 439/793

(57) ABSTRACT

In a terminal device of a switching device, a terminal screw with a washer is screwed in a terminal strip having a screw hole therein for connecting an external wire. The terminal strips are placed on terminal boards of power supply side and load side formed at both ends of a switching device case. A case cover covers the terminal screw, and a screwdriver is inserted through an insertion hole formed in an upper surface of the case cover to tighten the terminal screw. The terminal device includes a terminal lifter connected to the terminal screw for manually lifting the terminal screw upwardly from the upper surface of the case cover, so that the terminal screw is temporally attached to the case cover at a lifted position after the terminal screw is loosened and detached from the terminal strip with the screwdriver.

### BACKGROUND OF THE INVENTION AND RELATED ART STATEMENT

The invention relates to a terminal device of a switching device applied to a molded-case circuit breaker, an electromagnetic contactor, or the like for connecting external wires to main circuit terminals thereof.

In a terminal device of a switching device, terminal screws combined with washers are screwed in terminal strips (terminal strips with screw holes) extending to power terminal boards of supply side and load side formed at both ends of a switching device case. Various press terminals (round or U-shape) of electric wires are inserted into the terminal boards from outside, and are fastened with the terminal screws to be connected to the terminal strips. The terminal device typically has a structure in which a case cover covers upper surfaces of the terminal boards having the terminal strips and the terminal screws except for external wire insertion sides to prevent an electric shock due to exposure.

In the terminal device, the terminal screws may be provided with terminal lifters (tool for lifting the terminal screw) with finger hook parts (handles) formed of a resin, so that electric wires having round press terminals can be easily connected. In this case, the terminal screws are loosen with a screwdriver to be detached from the terminal strips, and the terminal screws are lifted from the terminal strips and engage a terminal cover of a switching device case to be temporarily held (refer to Japanese Patent Publication (Kokai) No. 2001-126606).

In Japanese Patent Publication (Kokai) No. 2001-126606, the terminal lifters of the terminal device are provided with finger hook parts projecting forward from circular screw hook parts fitted to heads of the terminal screws via connecting portions. In a state in which the terminal screws are loosen and detached from the terminal strips, the finger hook parts projecting forward from an end surface of the switching device case are manually lifted. Then, the connecting portions engage slit grooves formed in the terminal cover, so that the terminal screws are held at lifted positions.

In the conventional terminal device disclosed in Japanese Patent Publication (Kokai) No. 2001-126606, the finger hook parts of the terminal lifters project forward from the end surfaces of the switching device case at the terminal boards (power supply side and load side). Accordingly, when the switching case is installed in a switch board, a control board, or the like to connect external wires, or when a control module, an electromagnetic contactor, and the like located adjacent to the load side of the switching device are connected to each other via wires, the finger hook parts of the terminal lifters may interfere with the wires and make wiring difficult. Also, when a connection module, an electromagnetic contactor, and the like are located close to the switching device, it is difficult to provide a sufficient space between the switching device and the connection module, the electromagnetic contactor, and the like. Accordingly, it is difficult to hook a finger on the finger hook parts to lift the terminal lifters.

In view of the problems described above, an object of the present invention is to provide a terminal device of a switching device, in which it is easy to access to a terminal lifter from an upper surface of a case cover. Accordingly, when an external wire, a connection module, or the like is connected to the switching device, it is easy to engage and hold a terminal screw detached from a terminal strip to a case cover of the switching device at a lifted position with a simple operation without interfering the wiring operation, thereby improving operability. Further, the terminal device of the invention has a finger protecting function applicable to various external wiring operations, thereby preventing an electric shock due to exposure.

Further objects and advantages of the invention will be apparent from the following description of the invention.

### SUMMARY OF THE INVENTION

To attain the objects described above, in a terminal device of a switching device, a terminal screw with a washer is screwed in a terminal strip having a screw hole therein for connecting an external wire. The terminal strips are placed on terminal boards of power supply side and load side formed at both ends of a switching device case. A case cover covers the terminal screw, and a screwdriver is inserted through an insertion hole formed in an upper surface of the case cover to tighten the terminal screw. The terminal device includes a terminal lifter connected to the terminal screw for manually lifting the terminal screw upwardly from the upper surface of the case cover, so that the terminal screw is temporally attached to the case cover at a lifted position after the terminal screw is loosen and detached from the terminal strip with the screwdriver.

According to the present invention, the terminal lifter may be formed of a resin, and may include a support ring fitted on a peripheral surface of a head of the terminal screw and a pair of right and left lifting arms standing upwardly from a peripheral edge of the support ring. Ends of the lifting arms project upwardly from the case cover through arm insertion holes formed in the upper surface of the case cover.

According to the present invention, the lifting arms of the terminal lifter may be provided with engagement projections for engaging the terminal lifter with the arm insertion hole of the case cover at a position where the terminal screw is lifted.

According to the present invention, the lifting arms of the terminal lifter may be provided with operation holes at upper ends thereof for inserting a screwdriver from side to lift the terminal lifter. When the terminal screw detached from the terminal strip is lifted and held on the case cover, a tool such as a screwdriver is inserted into the operation holes, or a finger is hooked on the operation holes, so that the terminal lifter is easily lifted.

According to the present invention, the lifting arms of the terminal lifter may be provided with finger hook grooves at upper ends thereof, so that the terminal lifter is easily lifted.

According to the present invention, the lifting arms of the terminal lifter may be provided with notches at bases thereof for dividing the support ring to bend easily. When the terminal lifter is fitted to the terminal screw, the support ring is easily widened, so that the terminal lifter is easily fitted to the head of the terminal screw.

According to the present invention, box-shaped terminal covers formed of upper and lower separable sections are attached to both end portions of a case of the switching device for covering the terminal boards. Accordingly, it is possible to obtain a protective structure with a finger protection level of IP20.

According to the present invention, the terminal cover comprises an upper cover engaging and supported on the case cover of the switching device, and a lower cover engaging and supported on a lower surface of the upper cover. The upper cover is provided with a hole communicating with the screwdriver insertion hole of the case cover and a notch groove for inserting an external wire. The lower cover is provided with a front wall for closing an opening end of the notch groove.

According to the present invention, the upper cover is provided with an engagement pawl and the lower cover is provided with a plurality of engagement grooves in a vertical direction for engaging the lower cover with the upper cover. Accordingly, it is possible to engage the lower cover at a proper position in the vertical direction according to a size and number of external wires.

In the present invention, the terminal device is provided with the terminal lifter. Accordingly, as compared with a conventional terminal device in which a part (finger hook part) projects in a wiring direction from an end surface of a switching device case, the terminal lifter does not interfere with a wiring operation. Further, it is possible to access to the terminal lifter from the upper surface of the case cover of the switching device, thereby improving operability upon wiring as compared with the conventional terminal device.

In the invention, the box-shaped terminal cover is attached to the terminal device for covering the terminal boards. Accordingly, it is possible to obtain the protective structure with a finger protection level of IP20 (MEMA standard), thereby improving safety against an electrical shock. The terminal cover is divided into the upper cover and the lower cover. The lower cover engages the upper cover at a proper position in the vertical direction, so that the external wire insertion hole formed in the end surface of the cover can be widened or narrowed. Therefore, even if the size and number of external wires to be connected to the switching device are changed, it is possible to maintain the finger protecting function.

### BRIEF DESCRIPTION OF THE DRAWINGS

FIGS. 1A and 1B are views showing a terminal device according to an embodiment of the present invention, in which FIG. 1A is a perspective view showing an entire switching device equipped with the terminal device, and FIG. 1B is a perspective view showing a state that a terminal lifter is mounted on a terminal screw;

FIG. 2 is a perspective view showing the terminal lifter shown in FIG. 1B;

FIGS. 3A and 3B are views corresponding to FIG. 1B, wherein FIG. 3A is a front view of the terminal lifter, and FIG. 3B is a sectional view taken along line 3B-3B in FIG. 3A;

FIGS. 4A to 4D are views for explaining a wiring process of the terminal device shown in FIG. 1, wherein FIG. 4A shows a state that the terminal screw is temporarily fastened, FIG. 4B shows a state that the terminal screw is loosened, FIG. 4C shows a state that the terminal lifter is lifted, and FIG. 4D shows a state that an external wiring terminal is fastened;

FIG. 5 is a perspective view showing a state that a terminal cover is attached to a switching device case shown in FIG. 1;

FIG. 6 is a perspective view showing the switching device case cover shown in FIG. 5;

FIGS. 7A to 7C are views showing the terminal cove shown in FIG. 5, wherein FIG. 7A is a perspective view of an upper cover, FIG. 7B is a rear perspective view thereof, and FIG. 7C is a perspective view of a lower cover;

FIGS. 8A to 8C are views for explaining a process of attaching the terminal cover to the switching device upon wiring, wherein FIG. 8A shows a state that electric wires are connected to terminals of the switching device, FIG. 8B shows a state that the upper cover of the terminal cover is attached to the switching device case, and FIG. 8C shows a state that the lower cover engages the upper cover; and

FIGS. 9A and 9B are views for explaining a process of engaging the upper cover with the lower cover of the terminal cover, wherein FIG. 9A shows a state that the upper cover engages the lower cover at a lower position, and FIG. 9B shows a state that the upper cover engages the lower cover at an upper position.

### DETAILED DESCRIPTION OF PREFERRED EMBODIMENTS

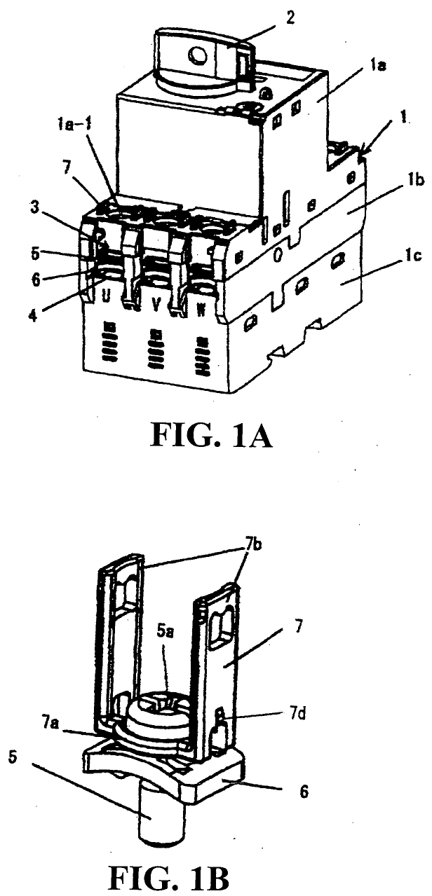

Hereunder, embodiments of the present invention will be described in detail with reference to the accompanying drawings. FIG. 1A is a view showing a switching device equipped with a terminal device according to the present invention (molded-case circuit breaker for a three-phase circuit), and FIG. 1B is a view showing a state that a washer and a terminal lifter are connected to a terminal screw.

In FIG. 1A, reference numeral 1 denotes a switching device case formed of a cover 1a, an intermediate case 1b, and a lower case 1c. Reference numeral 2 denotes a handle for a switching operation attached to an upper surface of the cover 1a. The switching device case 1 is provided with a power supply side terminal board and a load side terminal board at both ends thereof in a longitudinal direction. A terminal device 3 is arranged on the terminal board. The terminal device 3 is formed of main-circuit terminal strips 4 corresponding to U, V, and W phases drawn from a current breaking part inside the switching device case 1 and arranged in the left-to-right direction; terminal screws 5 engaging screw holes formed in the terminal strips 4; washers 6 attached to the terminal screws 5 for pressing wiring terminals; and terminal lifters (resin-molded product) 7 attached to the terminal screws 5.

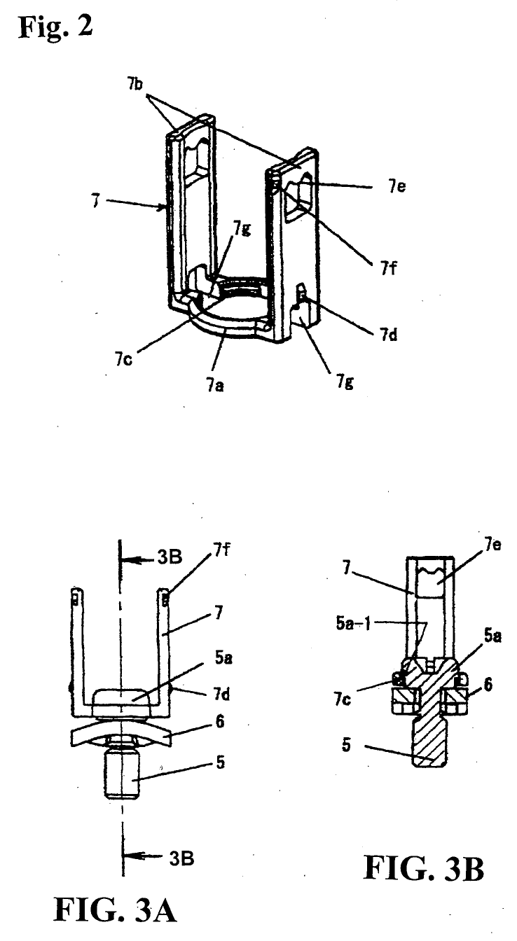

FIGS. 2, 3A and 3B show a detailed structure of the terminal lifter 7. The terminal lifter 7 is formed of a circular support ring 7a fitted on an outer periphery of a head 5a of the terminal screw 5, and a pair of right and left lifting arms 7b extending vertically from a periphery of the support ring 7a. A stepped hook 7c is formed on an inner peripheral surface of the support ring 7a. As shown in FIG. 3B, the hook 7c engages a stepped part 5a-1 formed at a peripheral edge of the screw head 5a in a state that the terminal lifter 7 is attached to the terminal screw 5. Each of the lifting arms 7b is provided with an engagement projection 7d for hooking the terminal lifter 7 to the cover 1a of the switching device case 1.

Further, each of the lifting arms 7b is provided with an operation hole 7e for inserting a tool such as a screwdriver from a side, and a finger hook groove 7f for hooking a finger so that the lifting arm 7b can be easily lifted. The engagement projection 7d may be formed on the cover 1a, and an engagement concave part may be formed in the arm 7b. A projection may be formed in place of the operation hole 7e. Each of the lifting arms 7b standing from right and left sides of the support ring 7a is also provided with U-groove shaped notches 7g at base corners thereof for dividing the support ring 7a into two portions in a circumference direction. Accordingly, the support ring 7a of the terminal lifter 7 can be easily bent and widened in an outer circumference direction when the support ring 7a is fitted on the head 6a of the terminal screw 5.

As shown in FIG. 1A, the cover 1a of the switching device case 1 is provided with screwdriver insertion holes 1a-1 corresponding to the terminal screws 5 of the U, V, and W phase, and pairs of right and left arm insertion holes corresponding to the lifting arms 7b of the terminal lifters 7. When the terminal lifters 7 attached to the terminal screws 5 are mounted on the terminal boards of the switching device, the lifting arms 7b of the terminal lifter 7 are inserted into the insertion holes 1a-2 formed in the case cover 1a, so that upper ends of the lifting arms 7b project from the upper surface of the case cover 1a.

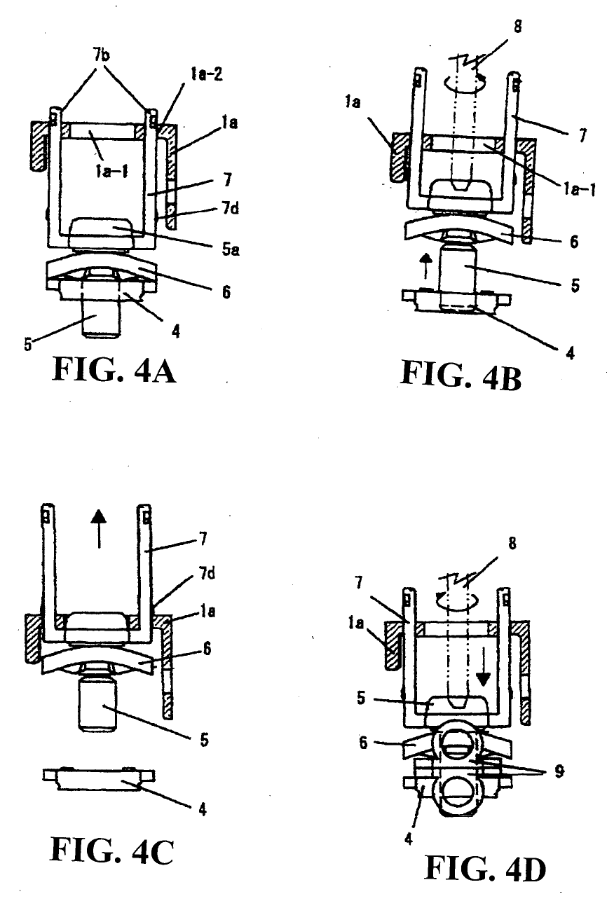

Referring to FIGS. 4A to 4D, a process of wiring on the terminal device 3 described above will be explained next. FIG. 4A shows a state that the terminal screw 5 is temporarily fastened. In this state, the terminal screw 5 is screwed into the screw hole of the terminal strip 4 via the washer 6, and the ends of the lifting arms 7b of the terminal lifter 7 attached to the terminal screw 5 slightly project from the upper surface of the case cover 1a. In the process of wiring in this state, as shown in FIG. 4B, a screwdriver 8 is inserted into the screwdriver insertion hole 1a-1 formed in the upper surface of the case cover 1a to fasten the terminal screw 5. When the terminal screw 5 is detached from the terminal strip 4, a finger is hooked on the lifting arms 7b of the terminal lifter 7 projecting from the upper surface of the case cover 1a, or the screwdriver 8 is inserted into the operation holes 7e (refer to FIG. 2) from a side to lift the terminal lifter 7.

FIG. 4C shows a state that the engagement projections 7d formed on the sides of the lifting arm 7b pass through the upper surface of the case cover 1a, and are hooked to the arm insertion hole 1a-2. Accordingly, the terminal screw 5 is lifted upward from the terminal strip 4 and held at the lifted position. A terminal (for example, a round press terminal) connected to an external wire is inserted into a gap between the terminal screw 5 and the terminal strip 4. Then, the terminal screw 5 is screwed into the screw hole of the terminal strip 4 from above the case cover 1a with the screwdriver 8. As a result, as shown in FIG. 4D, the press terminal 9 is fastened between the terminal strip 4 and the washer 6 to complete the wiring. When the wiring is changed, the terminal screw 5 is loosened and detached from the terminal strip 4, and the terminal lifter 7 is lifted and held on the case cover 1a for the wiring.

As described above, the terminal lifter 7 attached to the terminal device 3 has no part projecting forward from an end surface of the switching device case 1. Accordingly, when a wire is connected to the switching device, it is possible to access to and lift the terminal lifter 7 from above the switching device case cover 1a. Therefore, the terminal lifter does not interfere with the wiring as compared with a conventional terminal device (refer to Japanese Patent Publication (Kokai) No. 2001-126606). Even when the wiring is changed at a location where the switching device is installed close to a surrounding device such as an external wire and connection module, it is possible to easily lift and engage the terminal lifter, thereby completing the wiring in a short period of time.

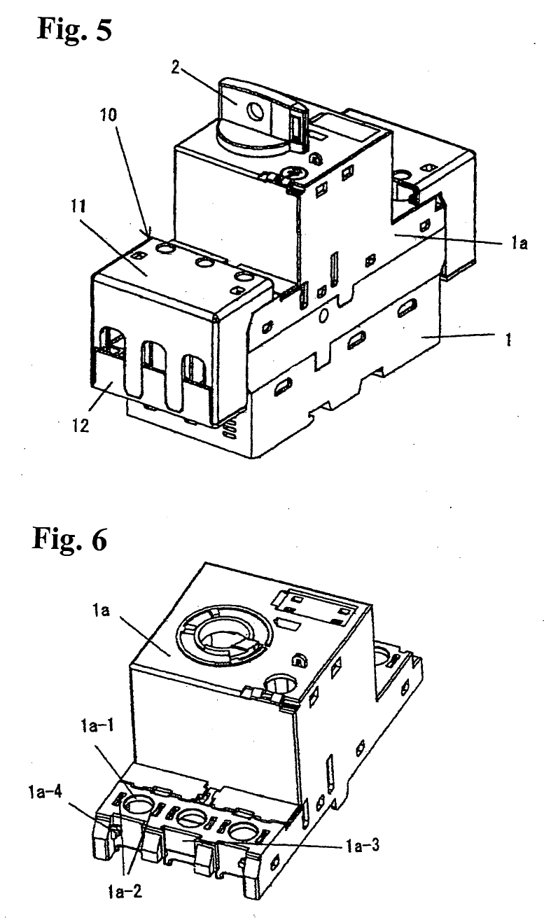

Referring to FIGS. 5 to 9A and 9B, the terminal device described above may be provided with a terminal cover to obtain a protective structure at a finger protection level of IP20, thereby improving safety upon maintenance and wiring of the switching device.

As shown in FIG. 5, closed-type terminal covers (resin-molded product) 10 are provided at both ends of the switching device case 1 as external attachments. Each of the terminal covers 10 has a box shape projecting from the end of the switching device case 1 in a wiring direction, and is formed of an upper cover 11 and a lower cover 12 combined with each other. The upper cover 11 is attached to a trapezoidal engagement groove 1a-3 formed at a center of the case cover 1a shown in FIG. 6 and engagement projections 1a-4 formed on both sides of the end of the case cover 1a. The lower cover 12 is fitted to a bottom surface of the upper cover 11 to engage the upper cover 11.

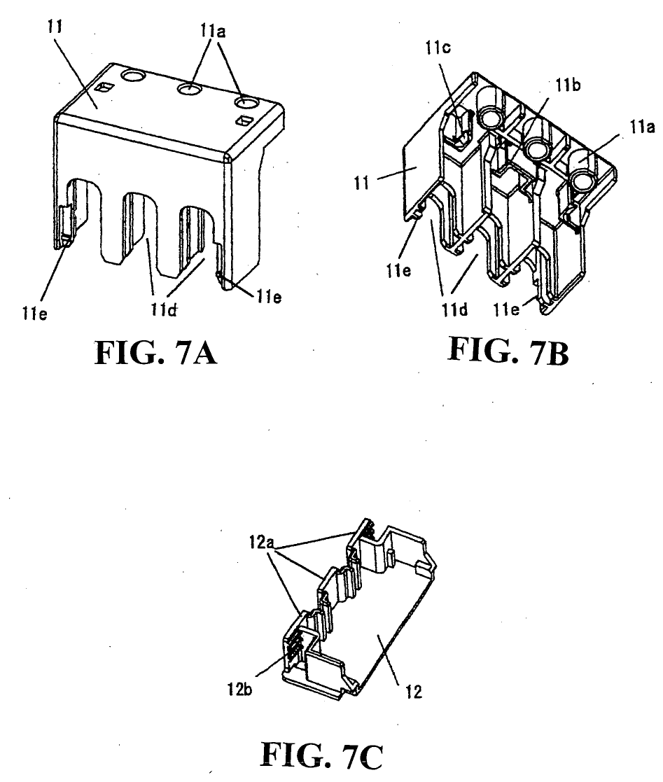

As shown in FIGS. 7A to 7C, the upper cover 11 is provided with cylindrical holes 11a communicating with the screwdriver insertion holes 1a-1 formed in the case cover 1a corresponding to the terminals, and a trapezoidal projection 11b and hook-shaped engagement projections 11c corresponding to the trapezoidal engagement groove 1a-3 and the engagement projections 1a-4, respectively. The upper cover 11 is also provided with inverted U-shaped notch grooves 11d as groove holes for inserting the respective external wires of U, V, and W phases (electric wires) at a lower end of a front surface thereof, and engagement pawls 11e for engaging and holding the lower cover 12 at right and left sides of the front surface thereof (refer to FIGS. 7A and 7B).

The lower cover 12 is provided with partition-shaped front walls 12a for closing opening ends of the U-shaped grooves 11d formed in the upper cover 11, and stepped engagement grooves 12b at multi-stages in the vertical direction for engaging the engagement pawls 11e (refer to FIG. 7C).

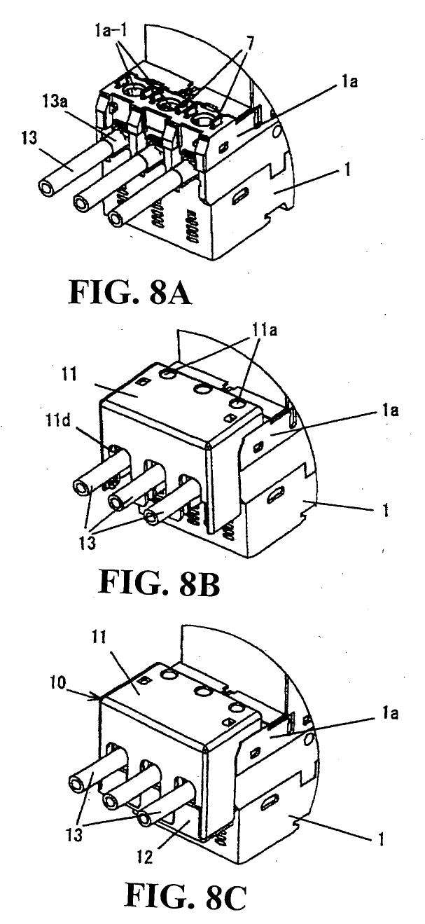

An installation process of the terminal cover 10 upon wiring of the witching device will be described next with reference to FIGS. 8A to 8C. FIG. 8A shows a wiring state in which the press terminals 13a of the electric wires (external wires) 13 are connected to the terminal boards of the switching device with the terminal lifters 7 shown in FIG. 1. In this state, the terminal screws are covered with the case cover 1a of the switching device, and the press terminals 13a of the electric wires 13 are exposed from the case cover 1a. Accordingly, when the wiring is inspected, a hand may touch the exposed press terminals (charged parts) and receive an electric shock. In order to prevent the electric shock, the terminal cover 10 is attached through the following procedure.

First, as shown in FIG. 8B, the upper cover 11 of the terminal cover is placed on the end of the switching device case cover 1a from above. The cylindrical holes 11a and the trapezoidal projection 11b are fitted into the screwdriver insertion holes 1a-1 and the trapezoidal groove 1a-3 (refer to FIG. 6) formed in the case cover 1a, respectively. Then, the engagement projections 11c engage the engagement projections 1a-4 of the case cover 1a to be fixed at a predetermined position. In this state, the electric wires 13 are fitted into the notch grooves 11d formed at the front surface of the upper cover 11, and the press terminals 13a are covered with the upper cover 11.

As shown in FIG. 8C, the lower cover 12 is fitted into the lower surface of the upper cover 11 from below, and the engagement grooves 12b formed on both sides of the lower cover 12 (refer to FIG. 7C) engage the engagement pawls 11e formed at the lower edge of the upper cover 11. In this state, the front walls 12a of the lower cover 12 (refer to FIG. 7C) are fitted into the notch grooves 11d of the upper cover 11 to close the opening ends thereof. As a result, the electrically charged part is covered with the terminal cover 10 and is not exposed outwardly with only a small gap between the terminal cover 10 and the electric wires 13 pulled out through the terminal cover 10, thereby obtaining a protective structure at a finger protection level of IP20.

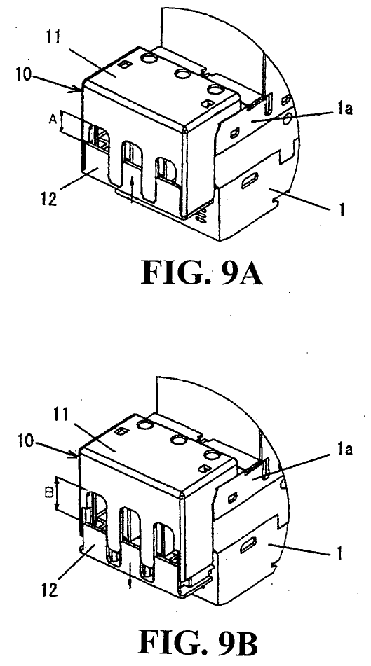

When the lower cover 12 engages the upper cover 11, the stepped engagement grooves 12b engage the engagement pawls 11e (refer to FIG. 7) at a proper position in the vertical direction. Accordingly, it is possible to adjust a height of the electric wire insertion holes of the terminal cover 10 defined by the notch grooves 11d of the upper cover 11 and the front walls 12a of the lower cover 12 as indicated by A and B in FIGS. 9A and 9B. As a result, when the electric wires with a different size and a number are connected to the terminal boards of the switching device, it is possible to adjust the height with a small gap between the electric wires and the electric wire insertion holes of the terminal cover 10 according to a size and number of the electric wires.

The disclosures of Japanese Patent Applications No. 2004-014152 filed on Jan. 22, 2004 and No. 2004-242660 filed on Aug. 23, 2004 are incorporated in the application.

While the invention has been explained with reference to the specific embodiments of the invention, the explanation is illustrative and the invention is limited only by the appended claims.

1. A terminal device for a switching device with a case cover, comprising:
a terminal strip disposed in the switching device and having a screw hole,
a terminal screw to be screwed into the screw hole, and
a terminal lifter attached to the terminal screw for lifting the terminal screw from above, said terminal lifter being able to engage the case cover for temporarily holding the terminal screw at a lifted position.

2. A terminal device according to claim 1, wherein said terminal lifter is formed of resin, and includes a support ring fitted to a head of the terminal screw and a pair of lifting arms extending upwardly from the support ring.

3. A terminal device according to claim 2, wherein said lifting arms include engagement projections for engaging edges of arm insertion holes of the case caver to hold the terminal screw at the lifted position.

4. A terminal device according to claim 2, wherein said lifting arms include operation holes at end portions thereof for inserting a tool from a side to lift the terminal screw.

5. A terminal device according to claim 2, wherein said lifting arms include finger hook grooves at end portions thereof for hooking a finger.

6. A terminal device according to claim 2, wherein said lifting arms include notch portions at base portions thereof so that the support ring deform easily.

7. A switching device comprising the terminal device according to claim 1, the case cover, and a terminal cover fitted into the case cover for covering the terminal device, said terminal cover having an upper section and a lower section fitted into the upper section to provide a finger protecting function.

8. A switching device according to claim 7, wherein said case cover includes a screwdriver insertion hole corresponding to the screw hole of the terminal strip for inserting a screwdriver to tighten the terminal screw.

9. A switching device according to claim 8, wherein said upper section is supported on the case cover and said lower section is supported on a lower surface of the upper section, said upper section including a hole corresponding to the screwdriver insertion hole and a notch groove for inserting an electric wire, said lower section having a front wall for closing the notch groove.

10. A switching device according to claim 7, wherein said upper section includes an engagement pawl, and said lower section includes engagement grooves for engaging the engagement pawl, said engagement grooves formed at a plurality of locations along a vertical direction.
